(19) United States
(12) Patent Application Publication
(10) Pub. No.: US 2016/0098750 A1
(43) Pub. Date: Apr. 7, 2016

(54) METHOD AND SYSTEM FOR PRESENTING CONTENT

(71) Applicant: David Lee Compton, Ventura, CA (US)

(72) Inventor: David Lee Compton, Ventura, CA (US)

(21) Appl. No.: 14/877,429

(22) Filed: Oct. 7, 2015

Related U.S. Application Data
(60) Provisional application No. 62/060,923, filed on Oct. 7, 2014.

(51) Int. Cl. G06Q 30/02; H04L 29/08

(52) U.S. Cl. CPC G06Q 30/0255; H04L 67/02; H04L 67/22

(57) ABSTRACT

A method of presenting content to a user is disclosed. The method includes identifying, with a processor, a first content based on the user visiting a first website, wherein the first website comprises the first content. Then, the method includes identifying, with a processor, a second content based on the first content, wherein the second content corresponds to a second website, wherein the second website is different from the first website. Finally, the method includes presenting, with a processor, the second content to the user based on the user visiting a third website, wherein the third website is different from each of the first website and the second website.

### CROSS-REFERENCE TO RELATED APPLICATIONS

This application claims benefit of U.S. provisional patent application No. 62/060,923, filed on Oct. 7, 2014, which is incorporated herein by reference in its entirety.

### FIELD OF THE INVENTION

The present invention relates generally to a system and method for redirecting users during a web browsing session.

### BACKGROUND

Retargeting is a marketing technique in which potential customers are targeted for advertising based on their internet usage history. Studies reveal that of all the web traffic that is received by a merchant website, only about two percent of the potential customers view a product and then purchase on their first visit. Retargeting is intended to induce the remaining ninety eight percent of the users to return to the website and purchase the item they had previously viewed. In traditional retargeting, a potential customer who visits a merchant website is tagged with an unobtrusive piece of code from that website. This piece of code is called a retargeting pixel. When the potential customer leaves that merchant website, advertisements from the merchant website are displayed on advertising spaces of subsequent web pages that the potential customer visits.

Therefore, only the merchant website, which is visited by a potential customer, will be able to tag the potential customer with the unobtrusive piece of code. Therefore, even if several merchant websites sell the same or very similar items, the advertisements that the potential customer sees as he surfs the Internet will only be for the merchant, which the potential customer has already visited. If a competing merchant website were able to advertise to the potential customer based on the potential customer's browsing habits at another merchant website, the competing merchant may win the sale.

Therefore, a new and improved system is desired to provide advertisements and other content from one website based on user's browsing history on another website.

### SUMMARY

A method of presenting content to a user is disclosed according to some embodiments. The method includes identifying, with a processor, a first content based on the user visiting a first website, wherein the first website comprises the first content. Then, the method includes identifying, with a processor, a second content based on the first content, wherein the second content corresponds to a second website, wherein the second website is different from the first website. Finally, the method includes presenting, with a processor, the second content to the user based on the user visiting a third website, wherein the third website is different from each of the first website and the second website.

A system for providing a browser plug-in configured for presenting content to a user is disclosed according to some embodiments. The system includes a server processor and a computer readable medium having program code which when executed by the server processor causes the browser plug-in to be installed on a client device associated with the user, wherein the client device comprises a client processor. Thereafter, executing the browser plug-in by the client processor causes identifying a first content based on the user visiting a first website, wherein the first website comprises the first content, identifying a second content based on the first content, wherein the second content corresponds to a second website, wherein the second website is different from the first website, and presenting the second content to the user based on the user visiting a third website, wherein the third website is different from each of the first website and the second website.

In a further embodiment, the disclosed system provides a browser extension that uses retargeting pixels to steer potential customers who have viewed a product at a non-preferred merchant website to a preferred merchant site, which sells the same product or a very similar product.

### BRIEF DESCRIPTION OF DRAWINGS

FIG. 1 is a block diagram of a system for presenting content to a user, in accordance with an embodiment.

FIG. 2 is a block diagram of a system for presenting content to a user, in accordance with some embodiments.

FIG. 3 illustrates a flowchart of a method for presenting content to a user, in accordance with an embodiment.

FIG. 4 is a functional block diagram of a browser plug-in, in accordance with some embodiments.

FIG. 5 illustrates an exemplary webpage, in accordance with an embodiment.

FIG. 6 illustrates an exemplary webpage, in accordance with an embodiment of FIG. 5.

FIG. 7 illustrates an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary.

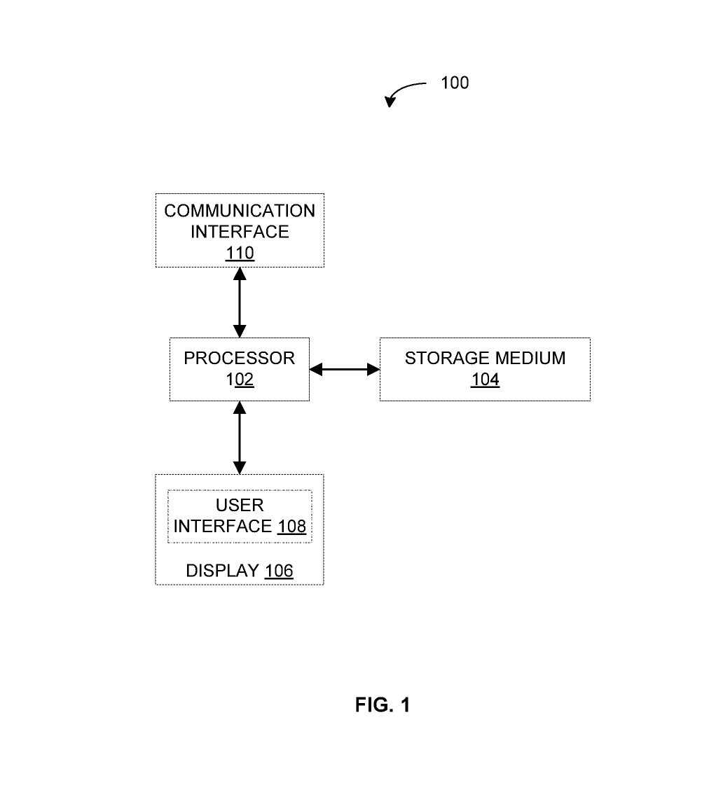

The present invention will be further illustrated with examples below. Referring to FIG. 1, a computing device 100 for presenting content to a user is illustrated in accordance with an embodiment. The computing device 100 may be a desktop, a laptop, a smartphone, a cell phone, or a tablet. The computing device 100 includes one or more processors (for example, a processor 102), a storage medium (e.g., a memory) 104, and a display 106. In an embodiment, storage medium 104 may be a computer readable medium. The computing device 100 interacts with users via a user interface 108 accessible to the users via display 106. Storage medium 104 stores instructions that, when executed by the processor 102, causes the processor 102 to present content to the user along with one or more websites in accordance with various embodiments. Further, the computing device 100 includes a communication interface 110, which allows the computing device 100 to interact with external devices.

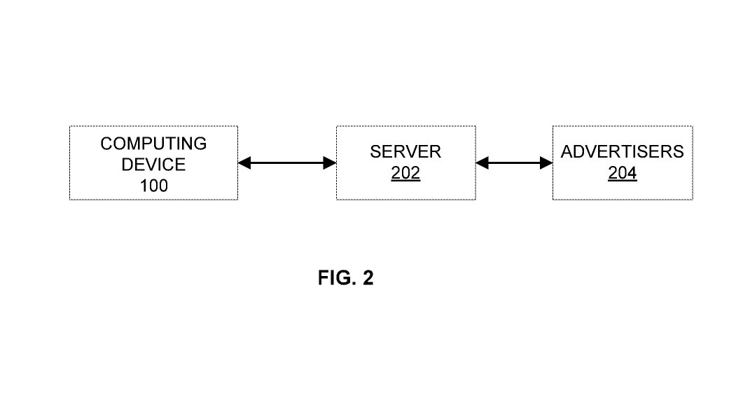

Now, referring to FIG. 2, the computing device 100 communicates with a server 202 via the communication interface 110. The user of the computing device 100 may access the server 202 via a web browser such as Microsoft Internet Explorer®, Google Chrome®, Mozilla Firefox®, Apple's Safari® and Opera®. The web browsers have been developed to accept plug-in modules. In general, plug-in modules are software extensions to an application. The server 202 provides a plug-in that is installed as an extension to the web browser being used by the user of the computing device 100. Further, the server 202 may provide software updates when available to keep the plug-in updated. One or more advertisers 204 register their websites with the server 202. Specifically, the one or more advertisers 204 submit their respective websites, which may be include a list of physical products, digital products, services, or any other content. The server 202 provides information comprising a set of data and metadata to the plug-in installed on the computing device 100. For example, the data may include a list of registered advertisers along with the list of physical products, digital products, services, or any other content. Further, the metadata may include a list of keywords associated with each listed physical product, digital product, service, or any other content.

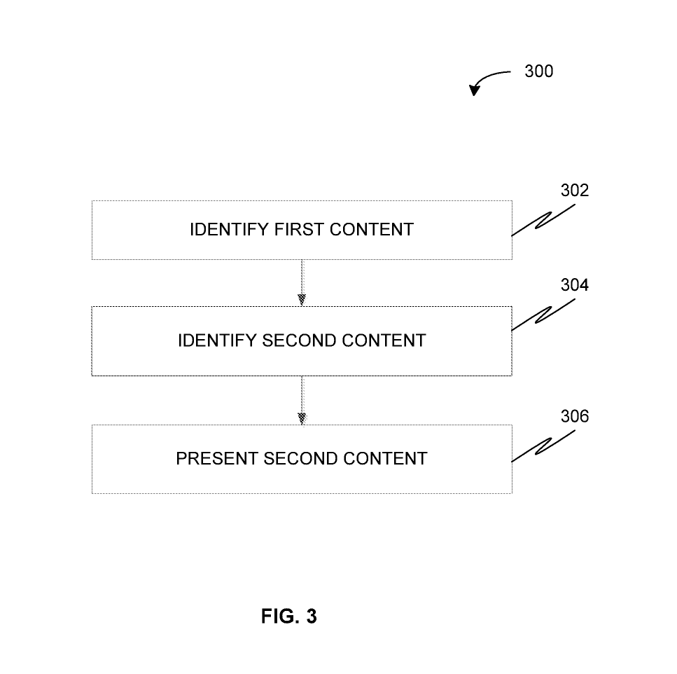

FIG. 3 illustrates a flowchart 300 of a method for presenting content to the user. The user visits a first website comprising a first content using a web browser. At 302, the processor 102 identifies the first content.

Thereafter, at 304, the processor 102 identifies a second content based on the first content. The second content corresponds to a second website, wherein the second website is different from the first website. The second website corresponds to one or more websites registered by the advertisers with the server 202. The second website is not initially visited by the user.

Each of the first content and the second content comprises one or both of data and metadata. For example, the first content may be a product listing, which includes the data comprising an advertised physical product and the metadata comprising keywords linked to the product listing.

Further, each of the first content and the second content corresponds to one or more topics. For example, the first content may be a product listing related to a topic such as furniture, smartphone or a pest control service. Similarly, the second content relates to one or more topics. In an embodiment, the server 202 identifies the second content based on one or more topics. In an embodiment, one or more topics for the first content may be included in the metadata associated with the first content. Similarly, one or more topics for the second content may be included in the metadata associated with the second content.

After visiting the first website, the user then moves to a third website. The third website is different from each of the first website and the second website. The third website may be related or unrelated to the first website and the second website. There is a plurality of potential third web sites. Each website visited by a web user following the web user's initial visit to the first website may be the third website. At 306, the processor 102 presents the second content to the user on the third website. For example, the second content may be placed in an advertisement space available on the third website.

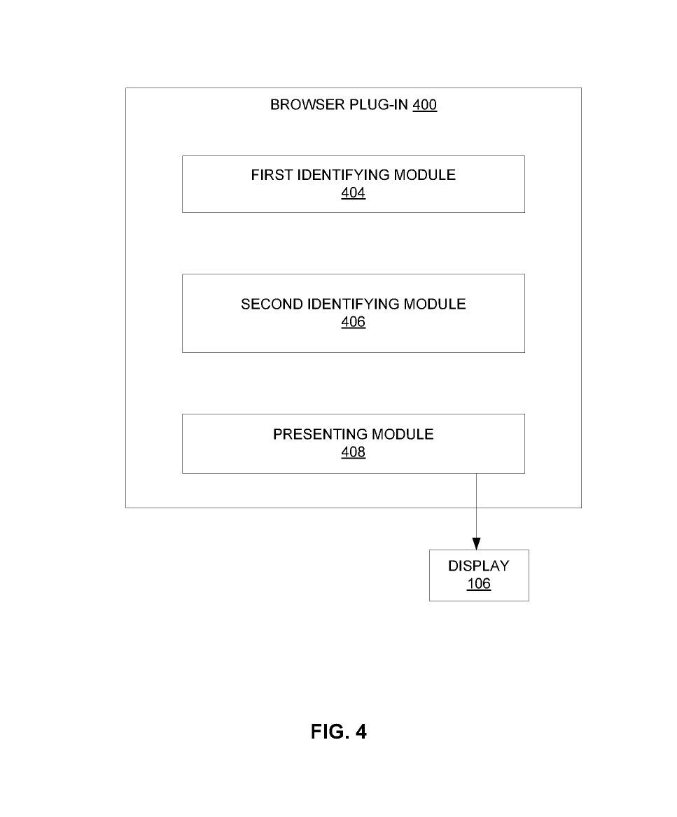

In an embodiment, the method shown in the flowchart 300 is executed by a browser plug-in. The browser plug-in is explained in detail in conjunction with FIG. 4 below.

Referring now to FIG. 4 illustrating a functional block diagram of a browser plug-in 400. The browser plug-in 400 includes a first identifying module 402, a second identifying module 404 and a presenting module 406. When the user visits the first website, the first identifying module 402 identifies the first content. Thereafter, the second identifying module 404 identifies the second content based on the first content. For example, the second identifying module 404 may identify the second content from the second website by comparing the first content metadata with the second content metadata, such that the identified second content is similar to the first content. Further, the second identifying module 404 inserts the second content retargeting pixel into the web browser. The retargeting pixel is an unobtrusive piece of computer code.

Finally, the presenting module 406 presents the second content to the user. The presenting module 406 sends the second content to the display 106. The presenting module 406 may present the second content based on the second content retargeting pixel inserted by the second identifying module 404.

Thereafter, the user may visit the second website via the second content. For example, user may perform a mouse click on the second content. The browser plug-in detects a visit of the user to the second website. An administrator of the browser plug-in 400 or the server 202 may receive compensation from the owner of second website for injecting the second merchant site retargeting pixel into the potential customer's web browser after the potential customer visited the first merchant site. The compensation may depend on number of visits generated by the browser plug-in installed on various computing devices, alternatively it may depend on the amount spent by the user on the second website.

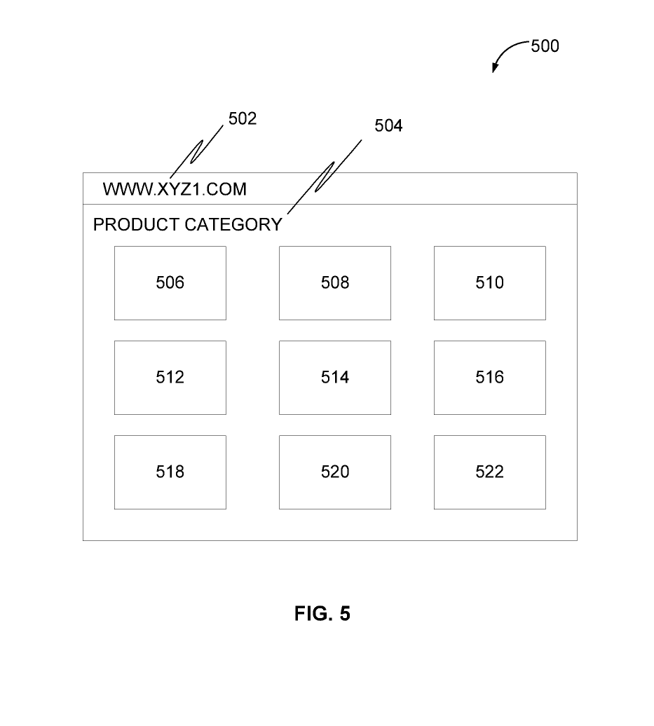

FIG. 5 illustrates an exemplary webpage 500, in accordance with an embodiment. The webpage 500 may be a webpage from a merchant website (the first website visited by the user) with a Uniform Resource Locator (URL) 502 (“WWW.XYZ1.COM”). The webpage 500 is related to a product category 504, wherein the webpage 500 lists a plurality of products 506-522 in the product category 522. When the user visits the webpage 500, the first identifying module 402 of the browser plug-in 400 identifies the first content from the webpage 500. For example, if the user views electronic appliances on the webpage 500, then the first content may include the text “electronic appliances” in the associated metadata.

Thereafter, the second identifying module 404 identifies the second content based on the first content. For example, the second content may include advertisements with metadata including the text “electronic appliances”, wherein these advertisements are obtained from a second website registered with the server 202. Further, the second identifying module 404 inserts the second content retargeting pixel into the web browser.

The second identifying module 404 may also include a price comparison module. The price comparison module enables the second identifying module 404 to compare the prices of the products with metadata “electronic appliances” available at two or more second merchant websites and then to choose a second merchant website with the lowest price. The second identifying module 404 then injects the second merchant website retargeting pixel into the potential customer's browser.

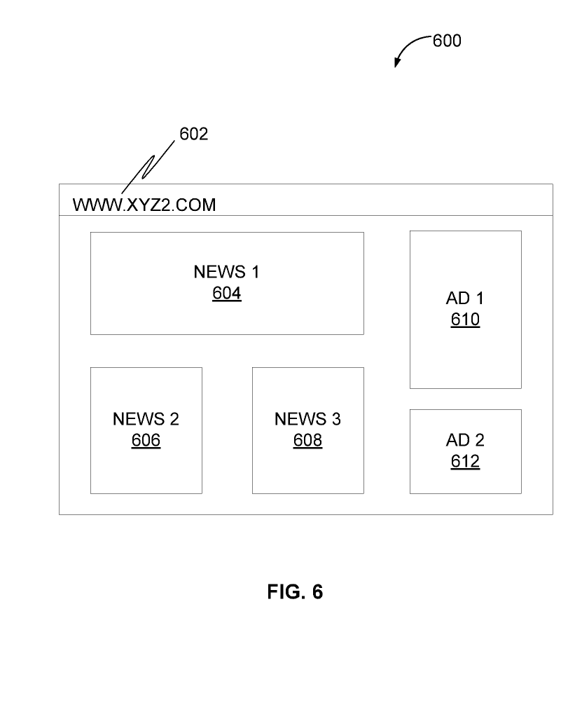

Thereafter, the user visits a webpage on a third website. FIG. 6 illustrates the webpage 600 visited by the user on the third website. The webpage 600 may be a webpage from a news website with a URL 602 (“WWW.XYZ2.COM”). The webpage 600 is designed to include a section 604 related to a first news “NEWS 1”, a section 606 related to a second news “NEWS 2”, a section 608 related to a third news “NEWS 3”, a first advertisement space 610 for displaying an advertisement “AD 1” and a second advertisement space 612 for displaying an advertisement “AD 2”. When the user visits the webpage 600, the presenting module 406 presents the second content in one of the first advertisement space 610 and the second advertisement space 612. The presenting module 406 may use the second content retargeting pixel to present the second content. The advertisements in the first advertisement space 610 and the second advertisement space 612 may be selected dynamically and then displayed to users. Therefore, different users may view different advertisements when they visit the webpage 600.

The disclosed system may be used for various applications. For instance, a potential homebuyer may visit a first realtor's website to browse for single-family homes in a specific neighborhood for sale by the first realtor. The browser plug-in may be used to enable a second realtor to inform the potential homebuyer of single family homes in that specific neighborhood for sale by the second realtor, potentially leading to a sale for the second realtor.

Further, if a user visits a first website to check the forecast in a particular city, the browser plug-in may allow a second website to show the forecast in that particular city to that user in the future, possibly causing the web user to switch his or her preferred website for weather information.

Similarly, if a potential voter visits a political website, the browser plug-in may allow a politician with similar ideological leanings to inform the potential voter of his candidacy, or to solicit donations from the potential voter.

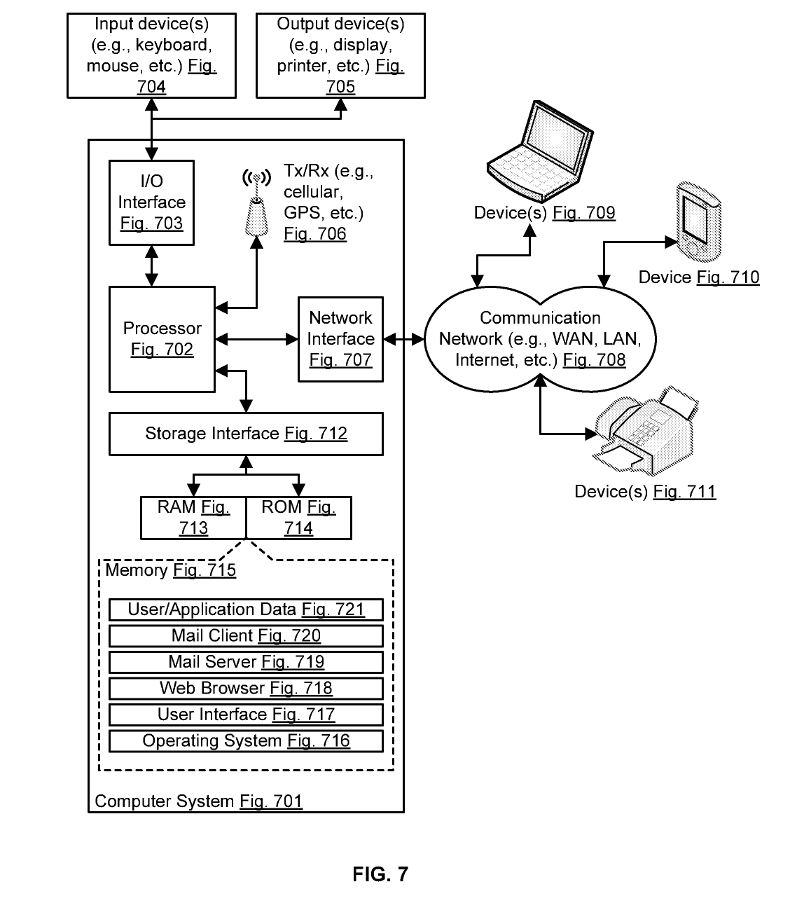

Referring now to FIG. 7, a block diagram of an exemplary computer system 701 for implementing embodiments consistent with the present disclosure is illustrated. Variations of computer system 701 may be used for implementing system 100. Computer system 701 may be the computing device 100. Computer system 701 may comprise a central processing unit (“CPU” or “processor”) 702 which may be the processor 102. Processor 702 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 702 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 702 may be disposed in communication with one or more input/output (I/O) devices via I/O interface 703. The I/O interface 703 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 703, the computer system 701 may communicate with one or more I/O devices. For example, the input device 704 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 705 may be a printer, fax machine, video display (e.g., cathode ray tube (CRT), liquid crystal display (LCD), light-emitting diode (LED), plasma, or the like), audio speaker, etc. In some embodiments, a transceiver 706 may be disposed in connection with the processor 702. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 702 may be disposed in communication with a communication network 708 via a network interface 707. The network interface 707 may communicate with the communication network 708. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 708 may include, without limitation, a direct interconnection, local area network (LAN), wide area network (WAN), wireless network (e.g., using Wireless Application Protocol), the Internet, etc. Using the network interface 707 and the communication network 708, the computer system 701 may communicate with devices 709, 710, and 711. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 701 may itself embody one or more of these devices.

In some embodiments, the processor 702 may be disposed in communication with one or more memory devices (e.g., RAM 713, ROM 714, etc.) via a storage interface 712. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices 715 may store a collection of program or database components, including, without limitation, an operating system 716, user interface application 717, web browser 718, mail server 719, mail client 720, user/application data 721 (e.g., any data variables or data records discussed in this disclosure), etc. The operating system 716 may facilitate resource management and operation of the computer system 701. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 717 may facilitate display, execution, interaction, manipulation, or operation of program components through textual or graphical facilities. For example, user interfaces may provide computer interaction interface elements on a display system operatively connected to the computer system 701, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 701 may implement a web browser 718 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 701 may implement a mail server 719 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 701 may implement a mail client 720 stored program component. The mail client may be a mail viewing application, such as Apple Mail, Microsoft Entourage, Microsoft Outlook, Mozilla Thunderbird, etc.

In some embodiments, computer system 701 may store user/application data 721, such as the data, variables, records, etc. (e.g., keywords, requirements, test cases, test scripts, sub requirements, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

I claim:

1. A method of presenting content to a user, the method comprising:
a. identifying, with a processor, a first content based on the user visiting a first website, wherein the first website comprises the first content;
b. identifying, with a processor, a second content based on the first content, wherein the second content corresponds to a second website, wherein the second website is different from the first website; and
c. presenting, with a processor, the second content to the user based on the user visiting a third website, wherein the third website is different from each of the first website and the second website.

2. The method of claim 1, wherein each of the first content and the second content comprises at least one of data and metadata.

3. The method of claim 1, wherein each of the first content and the second content corresponds to at least one topic.

4. The method of claim 1, wherein each of the first content and the second content corresponds to at least one of a product and a service.

5. The method of claim 1, wherein the second content is an advertisement.

6. The method of claim 1, wherein identifying the second content is further based on an attribute associated with the second content.

7. The method of claim 6, wherein the attribute is a cost associated the second content.

8. The method of claim 1 further comprising inserting a retargeting pixel into a browser operated by the user based on the user visiting the first website, wherein the retargeting pixel is configured for performing at least one of identifying the second content and presenting the second content.

9. The method of claim 1 wherein, the first content comprises a first metadata associated with at least one first topic, wherein the second content comprises a second metadata associated with at least one second topic, wherein identifying the second content comprises comparing the first metadata to the second metadata.

10. The method of claim 1, wherein at least one of the first website and the second website is visited by the user through a web browser comprising a browser plug-in, wherein the browser plug-in is configured for performing at least one of identifying the first content, identifying the second content and presenting the second content, the method further comprising paying a commission to a plug-in provider associated with the browser plug-in based on the user visiting the second website, wherein the paying is performed by a service provider associated with the second website.

11. A system for providing a browser plug-in configured for presenting content to a user, the system comprising a server processor and a computer readable medium having program code which when executed by the server processor causes the browser plug-in to be installed on a client device associated with the user, wherein the client device comprises a client processor, wherein executing the browser plug-in by the client processor causes:
a. identifying a first content based on the user visiting a first website, wherein the first website comprises the first content;
b. identifying a second content based on the first content, wherein the second content corresponds to a second website, wherein the second website is different from the first website; and
c. presenting the second content to the user based on the user visiting a third website, wherein the third website is different from each of the first website and the second website.

12. The system of claim 11, wherein each of the first content and the second content comprises at least one of data and metadata.

13. The method of claim 1, wherein each of the first content and the second content corresponds to at least one topic.

14. The system of claim 11, wherein each of the first content and the second content corresponds to at least one of a product and a service.

15. The system of claim 11, wherein the second content is an advertisement.

16. The system of claim 11, wherein identifying the second content is further based on an attribute associated with the second content.

17. The system of claim 16, wherein the attribute is a cost associated with the second content.

18. The system of claim 11, wherein executing the browser plug-in by the client processor further causes inserting a retargeting pixel into a browser executable on the client device based on the user visiting the first website, wherein the retargeting pixel is configured for performing at least one of identifying the second content and presenting the second content.

19. The system of claim 11 wherein, the first content comprises a first metadata associated with at least one of a first topic, wherein the second content comprises a second metadata associated with at least one of a second topic, wherein identifying the second content comprises comparing the first metadata to the second metadata.

20. The system of claim 11, wherein at least one of the first website and the second website is visited by the user through a web browser comprising the browser plug-in, wherein executing the browser plug-in by the client processor further causes detecting a visit of the user to the second website, wherein a commission is payable to a plug-in provider associated with the browser plug-in based on the detecting, wherein the commission is payable by a service provider associated with the second website.
